(19) United States
(12) Patent Application Publication
(10) Pub. No.: US 2026/0229667 A1
(43) Pub. Date: Aug. 6, 2026

(54) BATTERY PACK AND VEHICLE

(71) Applicant: BYD COMPANY LIMITED, Shenzhen (CN)

(72) Inventors: Chengjun ZHANG, Shenzhen (CN); Xubin GONG, Shenzhen (CN); Li YAO, Shenzhen (CN); Zhonglin ZHANG, Shenzhen (CN); Dongping CAI, Shenzhen (CN)

(73) Assignee: BYD COMPANY LIMITED, Shenzhen (CN)

(21) Appl. No.: 19/632,010

(22) Filed: Mar. 27, 2026

Related U.S. Application Data
(63) Continuation of application No. PCT/CN2024/076217, filed on Feb. 6, 2024.

(30) Foreign Application Priority Data
Sep. 28, 2023 (CN) 202322663050.5

(51) Int. Cl. H01M 50/209; H01M 10/42; H01M 10/613; H01M 10/6554; H01M 50/242; H01M 50/249; H01M 50/296; H01M 50/507; H01M 50/588; H01M 50/593

(52) U.S. Cl. CPC H01M 50/209; H01M 10/425; H01M 10/613; H01M 10/6554; H01M 50/242; H01M 50/249; H01M 50/296; H01M 50/507; H01M 50/588; H01M 50/593; H01M 2220/20

(57) ABSTRACT

A battery pack and vehicle are provided. The battery pack includes a plurality of layers of cell groups. Each of the layers of cell groups includes at least one sub-cell group. The at least one sub-cell group of each of the layers of cell groups includes a plurality of cells. The plurality of cells in each sub-cell group of the plurality of layers of cell groups extends in a first direction. The plurality of cells in each sub-cell group of the plurality of layers of cell groups is arranged in a second direction. The plurality of layers of cell groups are stacked in a third direction. The first direction, the second direction, and the third direction are different.

### CROSS-REFERENCE TO RELATED APPLICATIONS

The present application is a continuation of International Application No. PCT/CN 2024/076217, filed on Feb. 6, 2024, which claims priority to Chinese Patent Application No. 202322663050.5, filed on Sep. 28, 2023, and entitled “BATTERY PACK AND VEHICLE.” The entire disclosures of the prior applications are hereby incorporated by reference.

### TECHNICAL FIELD

The present disclosure relates to the field of batteries, including a battery pack and a vehicle.

### BACKGROUND

In a related technology, in a battery pack, cells are first assembled into a battery module, and then the battery module is integrated into a battery pack. However, in this integration manner, additional structures, such as tie rods and clamping plates for securing the cells need to be used to integrate the cells into the battery module, occupying specific space of the battery pack, and resulting in lower energy density of the battery pack. In addition, in a related technology, an arrangement manner of cells in a battery pack may not sufficiently utilize space in height and width directions of the battery pack.

### SUMMARY

Aspects of the present disclosure are provided to address at least one of the foregoing problems.

According to an aspect of the present disclosure, a battery pack is provided. The battery pack includes a plurality of layers of cell groups. Each of the layers of cell groups includes at least one sub-cell group. The at least one sub-cell group of each of the layers of cell groups includes a plurality of cells. The plurality of cells in each sub-cell group of the plurality of layers of cell groups extends in a first direction. The plurality of cells in each sub-cell group of the plurality of layers of cell groups is arranged in a second direction. The plurality of layers of cell groups are stacked in a third direction. The first direction, the second direction, and the third direction are different.

According to an aspect of the present disclosure, a battery pack is provided. The battery pack includes: at least two layers of cell groups, where each layer of cell group includes at least one sub-cell group, the sub-cell group includes a plurality of cells, the plurality of cells in the sub-cell group extend in a first direction, the plurality of cells in the sub-cell group are arranged in a second direction, and the at least two layers of cell groups are stacked in a third direction; and the first direction, the second direction, and the third direction are perpendicular to each other.

In an implementation of the present disclosure, each layer of cell group includes two sub-cell groups, and the two sub-cell groups are arranged in the first direction.

In an implementation of the present disclosure, a length of each cell ranges from 400 mm to 900 mm.

In an implementation of the present disclosure, each layer of cell group includes one sub-cell group.

In an implementation of the present disclosure, a length of each cell ranges from 600 mm to 1200 mm.

In an implementation of the present disclosure, an uppermost layer of cell group in the at least two layers of cell groups is disposed in at least one module housing, and the at least one sub-cell group is disposed in each module housing.

In an implementation of the present disclosure, a terminal post opening region is disposed in each module housing, and a terminal post of the cell is disposed in the terminal post opening region; and an insulating film is disposed on a surface of the module housing, and the insulating film at least covers a surface that is of the module housing and that is close to the terminal post opening region.

In an implementation of the present disclosure, the insulating film includes a first insulating film, where the first insulating film is disposed on a surface on a side that is of the module housing and that is away from the cell, and the first insulating film is close to the terminal post opening region.

In an implementation of the present disclosure, two terminal post opening regions are disposed in the module housing, two first insulating films are disposed on the surface on the side that is of the module housing and that is away from the cell, the two terminal post opening regions respectively correspond to the two first insulating films, and each first insulating film is close to a corresponding terminal post opening region.

In an implementation of the present disclosure, a width of the first insulating film ranges from 8 mm to 20 mm.

In an implementation of the present disclosure, the width of the first insulating film is 0.02 times to 0.05 times a total width of the module housing.

In an implementation of the present disclosure, a first busbar located above the module housing is separated from a module housing by using one first insulating film; and a width of a first insulating film opposite to a position of the first busbar is 0.12 times to 0.25 times a total width of the module housing.

In an implementation of the present disclosure, the insulating film further includes a second insulating film that is disposed on a surface on a side that is of the module housing and that is close to the cell.

In an implementation of the present disclosure, the first insulating film and the second insulating film are of an integrated structure.

In an implementation of the present disclosure, the battery pack further includes a cabinet, where the at least two layers of cell groups are disposed in the cabinet; and the cabinet has a first end and a second end opposite to each other in the second direction, and a power distribution box is disposed on the first end.

In an implementation of the present disclosure, a battery energy distribution unit is disposed in the power distribution box, and the battery energy distribution unit is electrically connected to the at least two layers of cell groups.

In an implementation of the present disclosure, an electric energy transmission interface is disposed on the second end of the cabinet; and the electric energy transmission interface is electrically connected to the battery energy distribution unit through the first busbar, the first busbar is located in the cabinet, and at least a part of the first busbar is located above the at least two layers of cell groups.

In an implementation of the present disclosure, cells in a same layer of cell group of the at least two layers of cell groups are connected in series, and each layer of cell group is electrically connected to the battery energy distribution unit through a second busbar.

In an implementation of the present disclosure, a shock-absorbing pad is disposed between the cabinet and the at least two layers of cell groups.

In an implementation of the present disclosure, a cooling plate is disposed between any two adjacent layers of cell groups of the at least two layers of cell groups.

According to an aspect of the present disclosure, a vehicle is provided. The vehicle includes: a vehicle body, and any of the battery packs disposed on the vehicle body.

According to the battery pack and the vehicle provided in aspects of the present disclosure, at least two layers of cell groups are disposed in the battery pack. Each layer of cell group includes at least one sub-cell group. The sub-cell group includes a plurality of cells. The plurality of cells in the sub-cell group extend in a first direction. The plurality of cells in the sub-cell group are arranged in a second direction. The at least two layers of cell groups are stacked in a third direction. The first direction, the second direction, and the third direction are different. For example, the first direction, the second direction, and the third direction are perpendicular to each other. In comparison with a related cell arrangement manner of a battery pack, in the present disclosure, the battery pack includes the at least two layers of cell groups, and each sub-cell group in the at least one layer of cell group is assembled in a module-free form, so that the cells can be more compactly arranged in the battery pack, more fully utilizing height space of the battery pack.

### BRIEF DESCRIPTION OF DRAWINGS

To describe technical solutions in aspects of the present disclosure, the following briefly describes the accompanying drawings. The accompanying drawings in the following description show some aspects of the disclosure, and a person of ordinary skill in the art may still derive other drawings from these accompanying drawings.

FIG. 1 is a diagram of a structure of a battery pack according to an aspect of the disclosure;

FIG. 2 is an exploded view of a structure of a battery pack according to another aspect of the disclosure;

FIG. 3 is a diagram of a circuit loop according to an aspect of the disclosure;

FIG. 4 is a cross-sectional view of a battery pack according to an aspect of the disclosure;

FIG. 5 is a diagram of a structure of a battery module according to an aspect of the disclosure;

FIG. 6 is a bottom view of the battery module in FIG. 5;

FIG. 7 is a rear view of the battery module in FIG. 5; and

FIG. 8 is a partial enlarged view of C in FIG. 7.

### DETAILED DESCRIPTION

The following describes example aspects of the present disclosure in further detail with reference to the accompanying drawings. The described aspects are merely some rather than all aspects of the present disclosure. The present disclosure is not limited to the example aspects described herein. Other aspects shall fall within the scope of the present disclosure.

Descriptions of terms in this disclosure are provided as examples only and are not intended to limit the scope of the disclosure.

As used herein, the phrase “at least one of A, B, or C” is intended to include A alone, B alone, C alone, or any combination thereof (e.g., A and B, A and C, B and C, or A, B, and C). The phrase “one of A or B” is intended to include A alone, B alone, or both A and B.

In the following descriptions, examples of details are given to provide an understanding of the disclosure. However, the disclosure may be implemented without one or more of these examples.

The disclosure can be implemented in different forms and should not be construed as limited to aspects described herein. On the contrary, these aspects are provided so that this disclosure will be understood, and the scope of the disclosure is conveyed to a person skilled in the art.

For an understanding of the present disclosure, structures are provided in the following descriptions, to explain the technical solution provided in the present disclosure. Example aspects of the present disclosure are described in further detail below. However, in addition to these descriptions, the present disclosure may have other implementations.

Implementations of the present disclosure are described in further detail below with reference to the accompanying drawings. When no conflict occurs, the following aspects and the features in the aspects can be mutually combined.

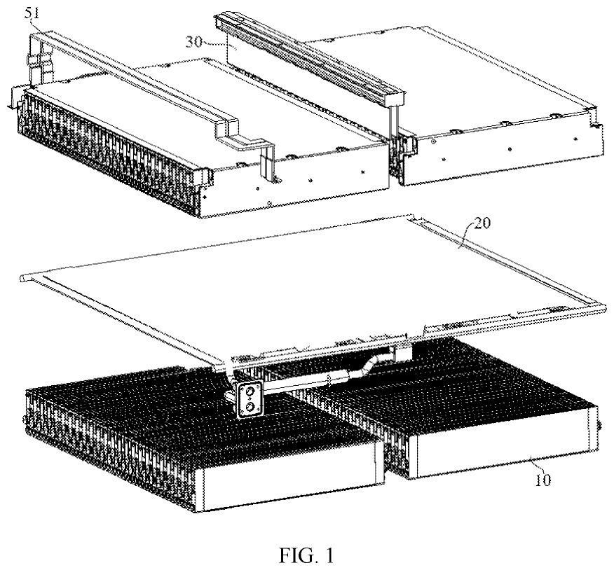

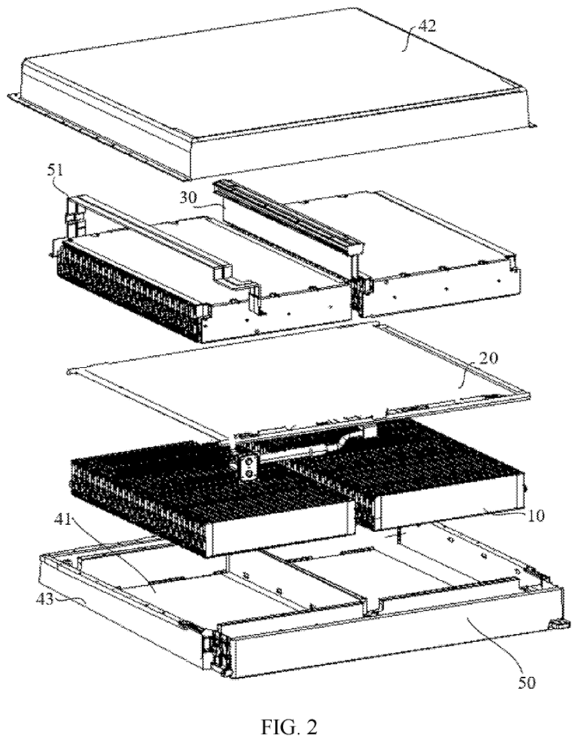

The present disclosure provides a battery pack. Referring to FIG. 1 and FIG. 2, the battery pack includes at least two layers of cell groups. Each layer of cell group includes at least one sub-cell group, the sub-cell group includes a plurality of cells 10, the plurality of cells 10 in the sub-cell group extend in a first direction, the plurality of cells 10 in the sub-cell group are arranged in a second direction, and the at least two layers of cell groups are stacked in a third direction; and the first direction, the second direction, and the third direction are different. In some examples, the first direction, the second direction, and the third direction are perpendicular to each other. In some examples, the plurality of cells 10 in the sub-cell group all extend in the first direction.

In the foregoing solution, the at least two layers of cell groups are disposed in the battery pack. Each layer of cell group includes the at least one sub-cell group. The sub-cell group includes the plurality of cells 10. The plurality of cells 10 in the sub-cell group extend in the first direction. The plurality of cells 10 in the sub-cell group are arranged in the second direction. The at least two layers of cell groups are stacked in the third direction. The first direction, the second direction, and the third direction are perpendicular to each other. In comparison with a related cell arrangement manner of a battery pack, in the present disclosure, the battery pack includes the at least two layers of cell groups, and each sub-cell group in the at least one layer of cell group is assembled in a module-free form, so that the cells 10 can be more compactly arranged in the battery pack, fully utilizing height space of the battery pack. The following describes the foregoing structures in further detail with reference to the accompanying drawings.

When a type of each cell 10 is determined, for example, each cell 10 may be a short cell, or a long cell. The short cell is a cell whose length does not exceed a first preset value, and the long cell is a cell whose length exceeds a second preset value. The first preset value and the second preset value may be equal or unequal, and even the first preset value may be greater than the second preset value. For example, a length of the short cell may range from 400 mm to 900 mm, and a length of the long cell may range from 600 mm to 1200 mm. Referring to FIG. 1, a shape of the cell 10 may be a short cell or a long cell with a thin thickness, or may be a rectangular block cell with a slightly thick thickness. The rectangular block cell may be, for example, but not limited to, a square aluminum-cased cell. The shape of the cell 10 may alternatively be a cylindrical cell. Electrodes of the cell 10 are disposed on two ends of a first direction of the cell 10, and may be positive and negative electrodes of the cell 10. The positive and negative electrodes of the cell 10 may be respectively disposed on the two ends of the first direction of the cell 10. In an example, one electrode is disposed on each of the two ends of the first direction of the cell 10, and the electrode may be a positive electrode or a negative electrode. In other aspects, the positive and negative electrodes of the cell 10 may alternatively be disposed only on one end of the first direction of the cell 10, or disposed on a surface of the cell 10 in a third direction.

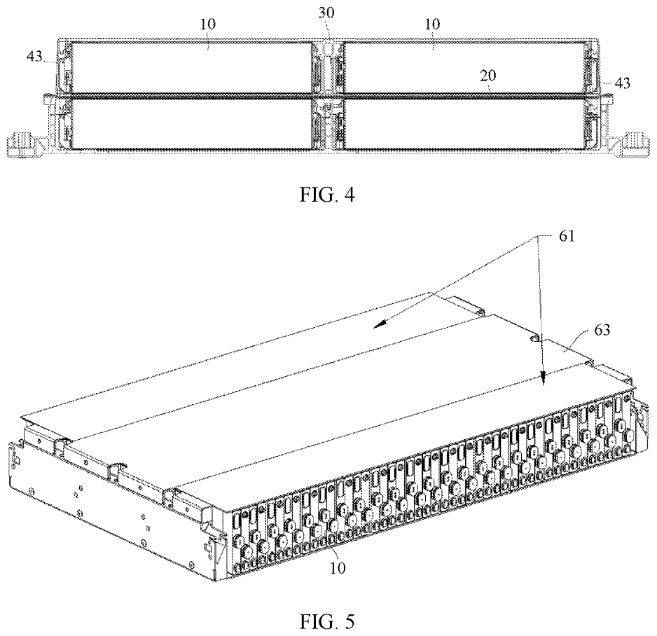

As shown in FIG. 1, FIG. 2, and FIG. 4, each layer of cell group includes a plurality of cells 10, and the plurality of cells 10 form at least one sub-cell group. In an example, each sub-cell group may include a plurality of cells 10, the plurality of cells 10 are arranged in a single row, and a plurality of cells 10 in a same row of cells 10 are arranged in a second direction. For example, a plurality of cells 10 in each row of cells 10 are sequentially arranged in a linear configuration in the same second direction. Each sub-cell group includes one row of cells 10. An arrangement direction of each row of cells 10 is different from the first direction. The second direction may be a direction substantially perpendicular to the first direction, so that positive and negative electrodes of each cell 10 are respectively located on the two ends of the first direction, thereby increasing a spacing between different electrodes, and reducing a risk of high-voltage arc breakdown. For example, when a long cell 10 with a thin thickness is used for the cell 10, the second direction may be a thickness direction of the cell 10, so that more cells 10 can be arranged in each layer of cell group, increasing density of the cell 10, thereby increasing energy density of the battery pack.

When a quantity of layers of cell groups in the battery pack is determined, the quantity of layers of cell groups that may be included in the battery pack may be two, three, four, five, or the like. The battery pack adopts an arrangement manner of at least two layers of cell groups, so that space of the battery pack can be more fully utilized, increasing energy density of the battery pack. When a quantity of rows of cells 10 in each layer of cell group is determined, for example, at least one layer of cell group may include one row of cells 10, two rows of cells 10, three rows of cells 10, four rows of cells 10, or more rows of cells 10. Each row of cells 10 may be used as one sub-cell group. For example, a plurality of cells 10 in each layer of cell group may be arranged in a single row, two rows, three rows, or the like. When at least two rows of cells 10 are arranged in each layer of cell group, arrangement density of the cells 10 can be increased, space inside the battery pack is more fully utilized, thereby increasing energy density of the battery pack. A stacking direction of the at least two layers of cell groups is the third direction, and the third direction is substantially perpendicular to both the first direction and the second direction, for example, the first direction, the second direction, and the third direction are perpendicular to each other. For example, when a long cell 10 with a thin thickness is used for the cell 10, the third direction may be a width direction of the cell 10. The foregoing description shows a stacking direction of different layers of cell groups.

For example, each layer of cell group may include at least two sub-cell groups. In an example, each layer of cell group may include two sub-cell groups, three sub-cell groups, or the like. For example, when each layer of cell group includes two sub-cell groups, the two sub-cell groups are arranged in the first direction, for example, the two sub-cell groups are arranged in a length direction of the cell. In some aspects, a length of each cell may range from 400 mm to 900 mm, for example, each cell 10 may be a short cell 10. Two rows of cells 10 in a same layer are arranged side by side, increasing arrangement density of the cells 10. For example, each layer of cell group may further include one sub-cell group, and a plurality of cells 10 in the sub-cell group are arranged in a single row. In some aspects, a length of each cell may range from 600 mm to 1200 mm, for example, each cell 10 may be a long cell 10, increasing arrangement density of the cells 10. For example, referring to FIG. 1 and FIG. 2, two adjacent sub-cell groups in each layer of cell group may be separated by using an insulating plate 30.

For example, in at least two layers of cell groups, at least a part of cells 10 may first be disposed in one module housing to assemble into a battery module. In an example, a part of cells 10 may be disposed in the module housing to assemble into a battery module, or all cells 10 may be disposed in the module housing to assemble into a battery module. In some aspects, an uppermost layer of cell group in the at least two layers of cell groups is disposed in at least one module housing, and the at least one sub-cell group is disposed in each module housing. One row of cells 10 are disposed in one module housing.

For example, regardless of whether the uppermost layer of cell group includes one sub-cell group or a plurality of sub-cell groups, cells 10, for example all cells 10, in the uppermost layer of cell group may be disposed in one module housing to assemble into one battery module. For example, regardless of whether the uppermost layer of cell group includes one row of cells 10 or at least two rows of cells 10, cells 10 in the uppermost layer of cell group may be disposed in one module housing to assemble into one battery module.

In some aspects, referring to FIG. 5, when the uppermost layer of cell group includes at least two rows of cells 10, each row of cells 10 is used as one sub-cell group. A quantity of rows of cells 10 in the uppermost layer of cell group may be equal to a quantity of module housings, and one row of cells 10 may be disposed in one module housing, for example, one sub-cell group is disposed in one module housing.

Referring to FIG. 1 and FIG. 5, in the at least two layers of cell groups, each row of cells 10 may be used as one battery module. For example, in rows of cells 10 in the battery pack, individual cells 10 in a part of rows of cells 10 may be directly arranged in the battery pack, or each row of cells 10 in a part of rows of cells 10 may be first assembled into one battery module, and then the battery module is disposed in the battery pack as one row of cells 10.

Referring to FIG. 1, for example, an uppermost layer and a lowermost layer of the at least two layers of cell groups may use different cell arrangement manners. In an example, each sub-cell group of the uppermost layer of cells 10 of the at least two layers of cell groups may be assembled into one battery module, and the battery module may be hoisted into the battery pack, utilizing ease of assembly of the battery module to enhance assembly efficiency and simplify overall assembly difficulty of the battery pack. In this case, rows of cells 10 of the lowermost layer of cells 10 of the at least two layers of cell group may be assembled into CTP. The CTP is a module-free arrangement manner. For example, cells 10 in the lowermost layer of cells 10 may be directly arranged in the battery pack, increasing the arrangement density of the cells 10. In other aspects, the lowermost layer of cell group may also use a module arrangement form similar to that used by the uppermost layer of cell group, or another cell arrangement form.

In some aspects, the uppermost layer of cell group and the lowermost layer of cell group of the at least two layers of cell groups may use a same cell arrangement manner. For example, both the lowermost layer of cell group and the uppermost layer of cell group may use a CTP arrangement form. In addition, selection of a specific row of cells 10 as the battery module is not limited to the foregoing manner in which the rows of cells 10 in the uppermost layer are used as the battery module. In addition, another disposition manner may be used.

The battery module may be assembled in a plurality of manners. For example, referring to FIG. 5, a terminal post opening region is disposed in each module housing. The terminal post opening region may be an opening provided in the module housing. A terminal post of the cell 10 is disposed in the terminal post opening region that is used as a terminal post region of the battery module. The terminal post region is an exposed region of the electrode of the cell 10 in the battery module. When the terminal post region is provided, the battery module may include two terminal post regions, for example, two terminal post opening regions are disposed on the module housing. The two terminal post opening regions may be respectively disposed on two ends of the length direction of the cell 10 or the first direction. When positive and negative electrodes of each cell 10 are respectively located on two ends of the length direction of the cell 10, two terminal post regions are formed on two ends of the plurality of cells 10 in the battery module. In other aspects, when the positive and negative electrodes of each cell 10 are led out from a same side of the cell 10, one terminal post region may be disposed on the battery module. In this case, one terminal post region is formed on a lead-out side of a plurality of cells 10 in the battery module. The electrodes may be led out from one end of the two ends of the length direction of the cell 10, and the correspondingly formed terminal post region is located on one end of the battery module in the first direction. Alternatively, the positive and negative electrodes of the cell 10 may be disposed in a region with a large surface area in the cell 10. In this case, because the cells 10 are arranged in the second direction, one or two correspondingly formed terminal post regions extend in the second direction.

For example, an insulating film may be disposed on a surface of the module housing, and the insulating film at least covers a surface that is of the module housing and that is close to the terminal post opening region, to insulate the terminal post region of the battery module from the module housing. For example, the insulating film may cover only a surface that is of the module housing and that is close to the terminal post opening region, or may cover all or a combination of surfaces of the module housing.

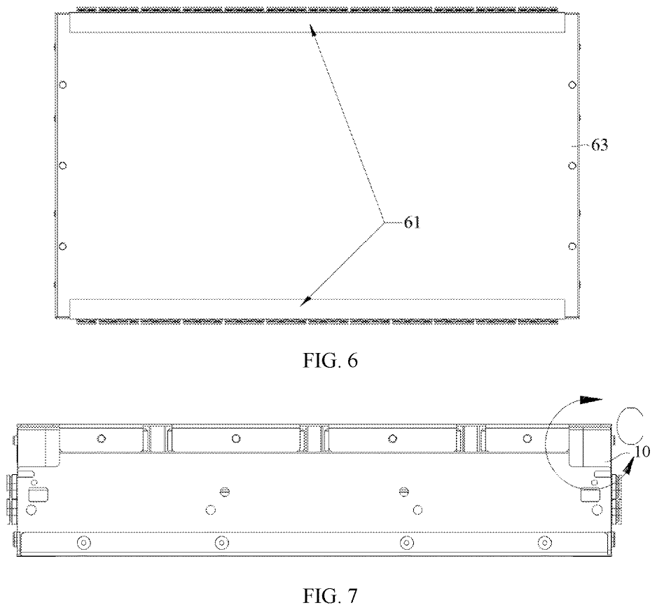

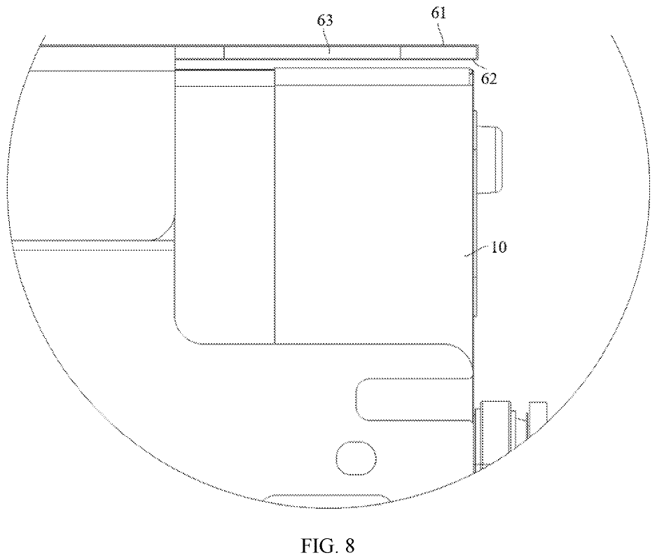

For example, referring to FIG. 5, FIG. 6, FIG. 7, and FIG. 8. The insulating film may include the first insulating film 61. The first insulating film 61 is disposed on a surface on a side that is of the module housing and that is away from the cell 10, and the first insulating film 61 is close to the terminal post opening region. For example, the first insulating film 61 is further disposed on a side of an outer surface that is of the module housing and that surrounds the terminal post opening region. In an example, the surface is an outer surface of the module housing. This can increase insulation, enhance a creepage distance, and help ensure high-voltage safety in an extreme case such as leakage and water ingress. For example, when the two terminal post opening regions on the module housing are located on two opposite ends or on one end in the first direction, first insulating films 61 may be disposed on both an upper surface and a lower surface that is of the module housing and that are away from the cell 10. Alternatively, the first insulating film 61 may be disposed on a side that is of a side surface of the module housing and that is away from the cell 10.

For example, referring to FIG. 5 and FIG. 6, when the two terminal post opening regions are disposed on the two opposite ends of the module housing in the first direction, two first insulating films 61 may be disposed on a surface on the side that is of the module housing and that is away from the cell 10. The two terminal post opening regions respectively correspond to the two first insulating films 61, and each first insulating film 61 is close to a corresponding terminal post region. In this case, two first insulating films 61 are disposed on each outer surface of upper and lower sides of the module housing at a position of each terminal post opening region. One first insulating film 61 is disposed at an edge of one terminal post opening region, and the other first insulating film 61 is disposed at an edge of the other terminal post opening region. This can increase insulation, enhance a creepage distance, and help ensure high-voltage safety in an extreme case such as leakage and water ingress.

For example, referring to FIG. 5, FIG. 7, and FIG. 8, a second insulating film 62 may be disposed on a surface on a side that is of the module housing and that is close to the cell 10, for example, the second insulating film 62 is disposed on a side that is of the module housing and that faces the cell 10. In an example, the surface is an inner surface of the module housing. The second insulating film 62 may be disposed on the upper surface and the lower surface of the module housing, or may be disposed on the side surface of the module housing.

For example, the module housing may include a metal pressing plate 63, the battery module integrates the plurality of cells 10 together by using the metal pressing plate 63, and the second insulating film 62 may be disposed between the metal pressing plate 63 and the cells 10, so that the second insulating film 62 separates the cells 10 from the metal pressing plate 63. This increases insulation, enhances a creepage distance, and helps ensure high-voltage safety in an extreme case such as leakage and water ingress. When a material of the second insulating film 62 and the first insulating film 61 is determined, the material of the second insulating film 62 and the first insulating film 61 may be, for example, but not limited to, an insulating material such as PI (polyimide) or rubber.

For example, referring to FIG. 8, the first insulating film 61 and the second insulating film 62 may be of an integrated structure. In this case, the first insulating film 61 may be considered as a part that is of the second insulating film 62 and that is formed by being outwardly folded from an inner surface of the module housing. Therefore, an edge of the metal pressing plate 63 can be wrapped, for example substantially or completely wrapped, thereby improving insulation effect. A manner of disposing the first insulating film 61 and the second insulating film 62 is not limited to the foregoing manner. In addition, another manner may be used. For example, the first insulating film 61 and the second insulating film 62 may be separately provided. The second insulating film 62 may be a strip-shaped insulating film, that is attached to the surface on the side that is of the module housing and that is away from the cell 10 along one terminal post opening region. A width of the first insulating film 61 refers to a spacing between two opposite sides of the strip insulating film in a narrower direction.

When the width of the first insulating film 61 is determined, the width of the first insulating film 61 may be not less than 8 mm, to improve insulation performance and a creepage distance, and help ensure high-voltage safety in an extreme case such as leakage and water ingress. For example, the width of the first insulating film 61 may be any value between 8 mm and 20 mm, such as 8 mm, 10 mm, 12 mm, 14 mm, 16 mm, 18 mm, 20 mm, or the like. The width of the first insulating film 61 may also be correlated with a total width of the module housing. The total width of the module housing is, for example, a total width of the battery module. When the total width of the module housing is wider, a width of each first insulating film 61 may be wider. When the total width of the module housing is narrower, the width of each first insulating film 61 may be narrower. For example, the width of the first insulating film 61 may be 0.02 times to 0.05 times the total width of the module housing. In an example, the width of the first insulating film 61 may be any value from 0.02 times to 0.05 times the total width of the module housing, for example, may be 0.02 times, 0.03 times, 0.05 times, or 0.05 times the total width of the module housing.

For example, referring to FIG. 1 and FIG. 5, a first busbar 51 located above the module housing is separated from a module housing by using one first insulating film 61, and the first busbar 51 may be configured to connect a power distribution box 50 and an external electric energy transmission interface, prevent the first busbar 51 from interfering with the battery module, and preventing the battery module from affecting normal operation of the first busbar 51. When the first busbar 51 is disposed on a side surface of the battery module, a corresponding first insulating film 61 is also disposed on the side surface of the battery module. For example, a width of the first insulating film 61 opposite to a position of the first busbar 51 may be 0.12 times to 0.25 times the total width of the module housing. For example, a width of the first insulating film 61 between the first busbar 51 and the battery housing is wider than a first insulating film 61 without a corresponding first busbar 51. In an example, the width of the first insulating film 61 between the first busbar 51 and the battery housing may be any value from 0.12 times to 0.25 times the total width of the module housing, for example, may be 0.12 times, 0.15 times, 0.18 times, 0.20 times, 0.22 times, and 0.25 times the total width of the module housing. This can increase insulation, enhance a creepage distance, and help ensure high-voltage safety in an extreme case such as leakage and water ingress.

In another aspect, the first insulating film 61 may be at least 8 mm wider than the first busbar 51, for example, the first insulating film 61 is wider than the first busbar 51, so that a distance between a side of the first busbar 51 and a side of the first insulating film 61 is not less than 8 mm. For example, the first insulating film 61 may be 8 mm to 20 mm wider than the first busbar 51. This can increase insulation, enhance a creepage distance, and help ensure high-voltage safety in an extreme case such as leakage and water ingress.

For example, the lowermost layer of cell group of the at least two layers of cell groups may be assembled into a battery module, and the uppermost layer of cell group of the at least two layers of cell groups may be assembled into CTP.

In other aspects, in addition to the foregoing manner, another arrangement manner may also be used. For example, the at least two layers of cell groups may be assembled in a CTC (cell-to-chassis) manner. In an example, CTC refers to a configuration where the cell 10 is directly integrated into the vehicle chassis. In this case, the cover plate 42 of the battery pack and the chassis of the vehicle may be integrated into an integrated structure.

In addition, referring to FIG. 1, FIG. 2, and FIG. 4, the battery pack may further include a housing, such as a cabinet, and at least two layers of cell groups are disposed in the housing. A plurality of setting manners may be used when the housing is disposed. For example, the housing may include a tray 41 configured to support the at least two layers of cell groups, may further include a cover plate 42 covering the at least two layers of cell groups, and may further include a side beam 43 connected between the cover plate 42 and the tray 41. The side beam 43 may be disposed on a side of the tray 41. In an example, the side beam 43 may be disposed on the tray 41 in a manner, for example, but not limited to, soldering, screw connection, clamping, or integration.

Referring to FIG. 1, FIG. 2, and FIG. 4, the housing has a first end and a second end opposite to each other in the second direction, for example, a plurality of cells 10 in each row of cells 10 are sequentially arranged from the first end of the cabinet to the second end of the cabinet. A power distribution box 50 may be disposed at the first end of the housing, so that the power distribution box 50 is directly opposite to a non-electrode end of each row of cells 10, thereby reducing a risk that gas from the cells 10 directly sprays onto a module, for example, but not limited to, the battery energy distribution unit in the power distribution box 50 during thermal runaway. In addition, this also facilitates an electrical connection between the module in the power distribution box 50 and each row of cells 10, thereby reducing a wiring length in the battery pack, and reducing a risk of high-voltage loop breakdown.

Referring to FIG. 1, a plurality of modules may be disposed in the power distribution box 50. A battery energy distribution unit may be disposed in the power distribution box 50, and a module such as a battery information collector may be disposed. When the battery energy distribution unit is electrically connected to the at least two layers of cell groups, the battery energy distribution unit may be electrically connected to at least one positive electrode and at least one negative electrode in the at least two layers of cell groups. For example, the battery energy distribution unit may have one positive terminal and one negative terminal. The positive terminal is electrically connected to one positive electrode of the at least two layers of cell groups. A manner of the electrical connection may be, for example, but not limited to, busbar, or flexible wire. The manner of the electrical connection between the battery energy distribution unit and the at least two layers of cell groups is not limited to the foregoing manner. In addition, another manner may be used. For example, cells 10 in a same layer of cell group of the at least two layers of cell groups may be connected in series, and each layer of cell group is electrically connected to the battery energy distribution unit through a second busbar 52. For example, a plurality of cells 10 in an upper layer of cell group are connected in series, a plurality of cells 10 in a lower layer of cell group are connected in series, and then the upper layer of cell group and the lower layer of cell group are connected in series through the second busbar 52 in the power distribution box 50, so that one power distribution box 50 may be disposed.

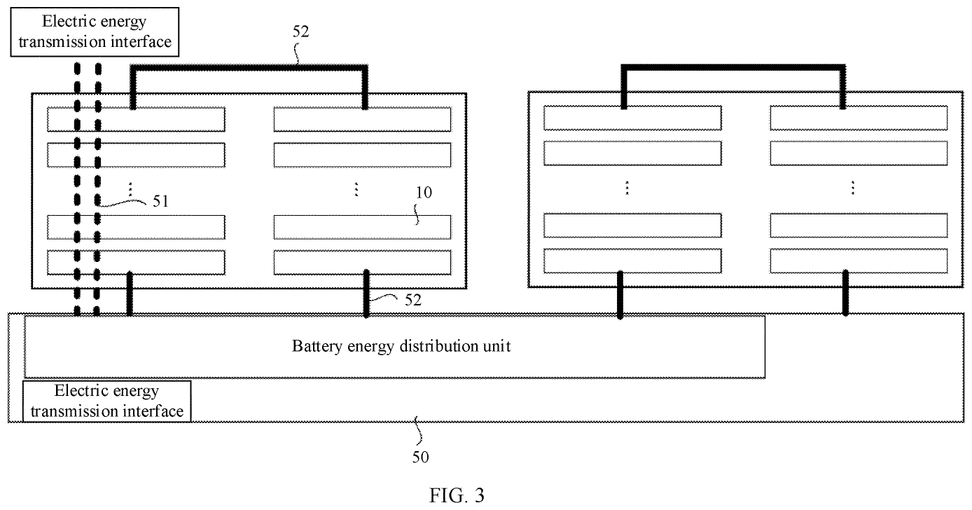

For example, referring to FIG. 3, two adjacent rows of cells 10 in the same layer of cell group may be electrically connected through the second busbar 52, for example, different rows of cells 10 in the same layer of cell group are electrically connected through the second busbar 52. This can reduce a quantity of interfaces through which the battery energy distribution unit is electrically connected to the at least two rows of cells 10, and a quantity of wires between the battery energy distribution unit and the at least two layers of cell groups, thereby reducing a risk of high-voltage breakdown. A material of the second busbar 52 may be, for example, but not limited to, a conductive copper bar. In FIG. 3, a left side refers to the upper layer of cell group, a right side refers to the lower layer of cell group, and the first busbar 51 is disposed above the upper layer of cell group. The second busbar 52 may be disposed at the first end or the second end of the housing, so as to prevent the second busbar 52 from interfering with the at least two layers of cell groups.

Referring to FIG. 1, one electric energy transmission interface may be disposed in the power distribution box 50, and the electric energy transmission interface may be directly electrically connected to the battery energy distribution unit in the power distribution box 50, so as to output electric energy externally. The electric energy transmission interface may be assembled in the power distribution box 50 through a plug connector. As shown in FIG. 1 and FIG. 2, an electric energy transmission interface may also be disposed at the second end of the housing, for example, two electric energy transmission interfaces are disposed in the battery pack. The electric energy transmission interface may be assembled at the second end of the housing through a plug connector. The electric energy transmission interface at the second end of the housing may be electrically connected to the battery energy distribution unit in a plurality of manners. For example, the electric energy transmission interface may be electrically connected to the battery energy distribution unit through a first busbar 51. The first busbar 51 is located in the housing. The first busbar 51 may be, for example, but not limited to, a conductive copper bar. Alternatively, at least a part of the first busbar 51 may be located above the at least two layers of cell groups, so as to prevent the first busbar 51 from affecting an arrangement structure of the cells 10. In an example, the first busbar 51 may alternatively be located above, and in some examples completely above, the at least two layers of cell groups. Alternatively, a part of the first busbar 51 may be located above the at least two layers of cell groups, and another part may be located on a side of the at least two layers of cell groups. As described above, the first busbar 51 is isolated from the uppermost layer of cell group by using a first insulating film 61, so as to prevent a fault such as an open circuit and a short circuit from occurring between the first busbar 51 and the uppermost layer of cell group. The first busbar 51 may be disposed above, and in some examples only above, the uppermost layer of cells 10, and does not need to be disposed in a lower layer of cells 10, thereby not occupying space in a lower layer.

Referring to FIG. 1, a cooling plate 20 may be disposed between any two adjacent layers of cell groups of the at least two layers of cell groups. Different layers of cell groups may be separated by cooling plates 20, so that the cells 10 are arranged in a grid shape. The cooling plate 20 may be a direct cooling plate, or may be a water cooling plate. In the foregoing manner, a heat radiation area between the cooling plates 20 and the cells 10 can be increased, and cooling and heat dissipation effect can be improved. In addition, the cooling plates 20 are arranged between the different layers of cell groups, so that the different layers of cell groups are effectively isolated, thereby preventing the different layers of cell groups from interfering with each other, and alleviating thermal runaway and high pressure. A plurality of setting manners may be used when the cooling plate 20 is disposed. For example, the lowermost layer of cell group may be bonded to the tray 41 by using structural adhesive, and the lowermost layer of cell group may be bonded to the cooling plate 20 by using thermally conductive adhesive. Then, the lowermost layer of cell group is inverted and placed into the tray 41. The uppermost layer of cell group may be bonded to a mechanical part of the uppermost layer of cell group by using structural adhesive in advance, assembled into a battery module, and then hoisted into the battery pack. A battery module in an uppermost layer may be bonded to the cooling plate 20 by using thermally conductive structural adhesive.

In addition, referring to FIG. 2, a shock-absorbing pad may be disposed between the housing and the at least two layers of cell groups. The shock-absorbing pad separates the cell group from an inner wall of the housing, thereby protecting the cell 10. A material of the shock-absorbing pad may be, for example, but is not limited to, an insulating and deformable material such as shock-absorbing foam, or elastic rubber.

In the foregoing implementations, the at least two layers of cell groups are disposed in the battery pack. Each layer of cell group includes the at least one sub-cell group. The sub-cell group includes the plurality of cells 10. The plurality of cells 10 in the sub-cell group extend in the first direction. The plurality of cells 10 in the sub-cell group are arranged in the second direction. The at least two layers of cell groups are stacked in the third direction. The first direction, the second direction, and the third direction are perpendicular to each other. In comparison with a related cell arrangement manner of a battery pack, in the present disclosure, the battery pack includes the at least two layers of cell groups, and each sub-cell group in the at least one layer of cell group is assembled in a module-free form, so that the cell group can be more compactly arranged in the battery pack, fully utilizing height space of the battery pack.

In addition, the present disclosure provides a vehicle. Referring to FIG. 1 to FIG. 8, in some aspects, the vehicle includes: a vehicle body, and any one of the battery packs disposed on the vehicle body. The vehicle may be, for example, but not limited to, a passenger vehicle, a truck, or a special-purpose engineering vehicle. The vehicle body includes structures such as a frame, a wheel, a transmission, and a steering wheel, and any one of the battery packs disposed on the vehicle body.

The present disclosure is described with the foregoing aspects, but it should be understood that the foregoing aspects are for purposes of illustration and description, and are not intended to limit the present disclosure. A person skilled in the art may understand that, the present disclosure is not limited to the foregoing aspects, and variations and modifications may be made according to teachings of the present disclosure, and these variations and modifications fall within the scope of the present disclosure.

Reference numerals: 10: cell; 20: cooling plate; 30: insulating plate; 41: tray; 42: cover plate; 43: side beam; 50: power distribution box; 51: first busbar; 52: second busbar; 61: first insulating film; 62: second insulating film; 63: metal pressing plate.

1. A battery pack, comprising:
a plurality of layers of cell groups, each of the layers of cell groups including at least one sub-cell group, and the at least one sub-cell group of each of the layers of cell groups including a plurality of cells, wherein
the plurality of cells in each sub-cell group of the plurality of layers of cell groups extends in a first direction,
the plurality of cells in each sub-cell group of the plurality of layers of cell groups is arranged in a second direction,
the plurality of layers of cell groups are stacked in a third direction, and
the first direction, the second direction, and the third direction are different.

2. The battery pack according to claim 1, wherein
each of the layers of cell groups includes a plurality of sub-cell groups, and
the plurality of sub-cell groups of each of the layers of cell groups is arranged in the first direction.

3. The battery pack according to claim 2, wherein a length of the plurality of cells in each sub-cell group of the plurality of layers of cell groups ranges from 400 mm to 900 mm.

4. The battery pack according to claim 1, wherein each of the layers of cell groups includes only one sub-cell group.

5. The battery pack according to claim 4, wherein a length of the plurality of cells in each sub-cell group of the plurality of layers of cell groups ranges from 600 mm to 1200 mm.

6. The battery pack according to claim 1, further comprising:
at least one module housing, the at least one sub-cell group of an uppermost layer of the plurality of cell groups being disposed in the at least one module housing.

7. The battery pack according to claim 6, further comprising:
a first insulating film, wherein
a module housing of the at least one module housing includes a terminal post opening region,
a terminal post of the plurality of cells in a sub-cell group of the at least one sub-cell group of the uppermost layer is disposed in the terminal post opening region, and
the first insulating film is disposed on a portion of an outer surface of the module housing that is proximate to the terminal post opening region.

8. The battery pack according to claim 6, further comprising:
a plurality of first insulating films, wherein
a module housing of the at least one module housing includes a first terminal post opening region and a second terminal post opening region,
a first terminal post of the plurality of cells in a sub-cell group of the at least one sub-cell group of the uppermost layer is disposed in the first terminal post opening region,
a second terminal post of the plurality of cells in the sub-cell group of the at least one sub-cell group of the uppermost layer is disposed in the second terminal post opening region,
a first one of the first insulating films is disposed on a first portion of an outer surface of the module housing that is proximate to the first terminal post opening region, and
a second one of the first insulating films is disposed on a second portion of the outer surface of the module housing that is proximate to the second terminal post opening region.

9. The battery pack according to claim 7, wherein a width of the first insulating film ranges from 8 mm to 20 mm.

10. The battery pack according to claim 7, wherein a width of the first insulating film is 0.02 times to 0.05 times a total width of the at least one module housing.

11. The battery pack according to claim 7, further comprising:
a first busbar that is separated from a battery module by the first insulating film, wherein a width of the first insulating film is 0.12 times to 0.25 times a total width of the battery module.

12. The battery pack according to claim 7, further comprising:
a second insulating film disposed on an inner surface of a side of the module housing.

13. The battery pack according to claim 12, wherein the first insulating film and the second insulating film are part of an integrated structure.

14. The battery pack according to claim 1, further comprising:
a housing in which the plurality of layers of cell groups are disposed, the housing including a first end and a second end at opposing sides of the housing in the second direction; and
a power distribution box disposed at the first end of the housing.

15. The battery pack according to claim 14, wherein
the power distribution box includes a battery energy distribution unit, and
the battery energy distribution unit is electrically connected to the plurality of layers of cell groups.

16. The battery pack according to claim 15, further comprising:
an electric energy transmission interface disposed at the second end of the housing, wherein the electric energy transmission interface is electrically connected to the battery energy distribution unit through a first busbar in the housing, and
at least a part of the first busbar is above the plurality of cell groups.

17. The battery pack according to claim 15, wherein
the plurality cells in each of the at least one sub-cell group in a same layer of the plurality of layers of cell groups is connected in series, and
each of the layers of cell groups is electrically connected to the battery energy distribution unit through a second busbar.

18. The battery pack according to claim 14, further comprising:
a shock-absorbing pad between the housing and the plurality of layers of cell groups.

19. The battery pack according to claim 1, further comprising:
a cooling plate between adjacent layers of the plurality of layers of cell groups.

20. A vehicle, comprising:
a vehicle body; and
a battery pack, the battery pack including:
a plurality of layers of cell groups, each of the layers of cell groups including at least one sub-cell group, and the at least one sub-cell group of each of the layers of cell groups including a plurality of cells, wherein
the plurality of cells in each sub-cell group of the plurality of layers of cell groups extends in a first direction,
the plurality of cells in each sub-cell group of the plurality of layers of cell groups is arranged in a second direction,
the plurality of layers of cell groups are stacked in a third direction, and
the first direction, the second direction, and the third direction are different.
